(19) United States
(12) Patent Application Publication
(10) Pub. No.: US 2009/0245225 A1
(43) Pub. Date: Oct. 1, 2009

(54) Method and Apparatus of Transmission Time Interval Bundling Management

(76) Inventor: Li-Chih Tseng, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/416,157

(22) Filed: Apr. 1, 2009

Related U.S. Application Data
(60) Provisional application No. 61/041,250, filed on Apr. 1, 2008.

(51) Int. Cl. H04J 3/00

(52) U.S. Cl. 370/345

(57) ABSTRACT

A method for managing transmission time interval bundling transmission in a user equipment of a wireless communication system includes forming a plurality of packets to be transmitted, and selecting a fixed time interval or a dynamic time interval for repeatedly transmitting each packet of the plurality of packets to a network end of the wireless communication system.

### CROSS REFERENCE TO RELATED APPLICATIONS

This application claims the benefit of U.S. Provisional Application No. 61/041,250, filed on Apr. 1, 2008 and entitled “Multiple HARQ transmissions and DRX short cycle timer”, the contents of which are incorporated herein by reference.

### BACKGROUND OF THE INVENTION

1. Field of the Invention

The present invention relates to a method and apparatus of transmission time interval bundling transmission management in a wireless communication system, and more particularly, to a method and apparatus for performing transmission time interval bundling transmission with two transmission methods in a wireless communication system.

2. Description of the Prior Art

Long Term Evolution wireless communications system (LTE system), an advanced high-speed wireless communications system established upon the 3G mobile telecommunications system, supports only packet-switched transmission, and tends to implement both Medium Access Control (MAC) layer and Radio Link Control (RLC) layer in one single communication site, such as in Node B alone rather than in Node B and RNC (Radio Network Controller) respectively, so that the system structure becomes simple.

In LTE, a technique of transmission time interval (TTI) bundling is introduced for improving uplink coverage according to the prior art. TTI bundling is performed by repeatedly transmitting a same packet with default times, and those repeatedly transmitted packets are named a bundle. UEs in cell boundary utilizing TTI bundling can reduce transmission delay and signaling of control channels for enhancing reliability and accuracy of transmission, to improve LTE uplink coverage.

Targeting on TTI bundling technique, the prior art has not addressed related transmission patterns, which may cause transmission delay and waste of wireless resources.

### SUMMARY OF THE INVENTION

It is therefore an objective of the present invention to provide a method and apparatus of transmission time interval bundling transmission management in a wireless communication system.

The present invention discloses a method for managing transmission time interval bundling transmission in a user equipment of a wireless communication system, which comprises forming a plurality of packets to be transmitted, and selecting a fixed time interval or a dynamic time interval for repeatedly transmitting each packet of the plurality of packets to a network end of the wireless communication system.

The present invention further discloses a communication device for managing transmission time interval bundling transmission in a user equipment of a wireless communication system, which comprises a processor for executing a process, and a storage device, coupled to the processor, for storing a program for executing the process. The process comprises forming a plurality of packets to be transmitted, and selecting a fixed time interval or a dynamic time interval for repeatedly transmitting each packet of the plurality of packets to a network end of the wireless communication system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system.

FIG. 2 is a functional block diagram of a wireless communication device.

FIG. 3 is a schematic diagram of the program shown in FIG. 2.

FIG. 4 is a flow chart of a process according to an embodiment of the present invention.

FIG. 5 is a schematic diagram of performing transmission time interval bundling with a fixed time interval according to an embodiment of the present invention.

FIG. 6 is a schematic diagram of performing transmission time interval bundling with a dynamic time interval according to an embodiment of the present invention.

### DETAILED DESCRIPTION

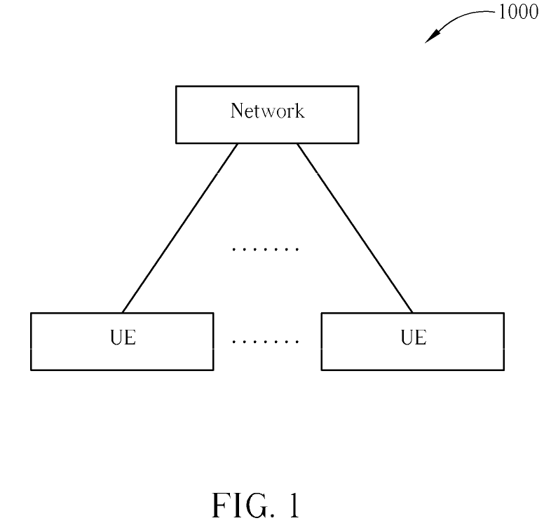

Please refer to FIG. 1, which is a schematic diagram of a wireless communications system 1000. The wireless communications system 1000 is preferred to be a Long Term Evolution (LTE) communications system, and is briefly formed with a network terminal and a plurality of user equipments. In FIG. 1, the network terminal and the user equipments are simply utilized for illustrating the structure of the wireless communications system 1000. Practically, the network terminal may include a plurality of evolved base stations (eNBs), an evolved UMTS radio access network (EUTRAN) and so on according to actual demands, and the user equipments (UEs) can be apparatuses such as mobile phones, computer systems, etc.

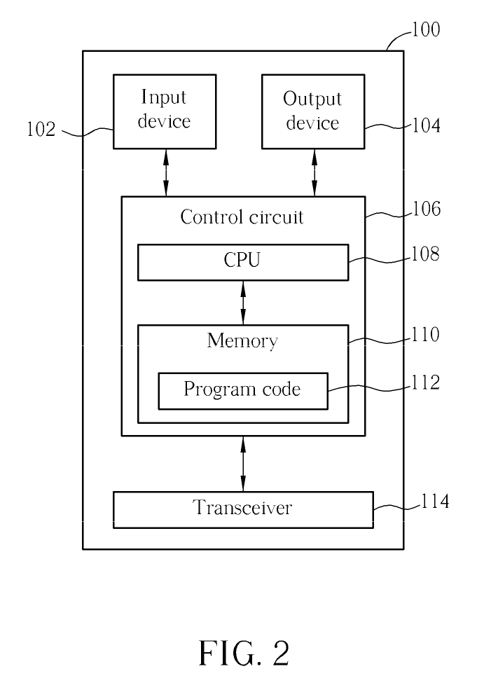

Please refer to FIG. 2, which is a functional block diagram of a communications device 100. The communications device 100 can be utilized for realizing the UEs in FIG. 2. For the sake of brevity, FIG. 2 only shows an input device 102, an output device 104, a control circuit 106, a central processing unit (CPU) 108, a memory 110, a program 112, and a transceiver 114 of the communications device 100. In the communications device 100, the control circuit 106 executes the program 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3.

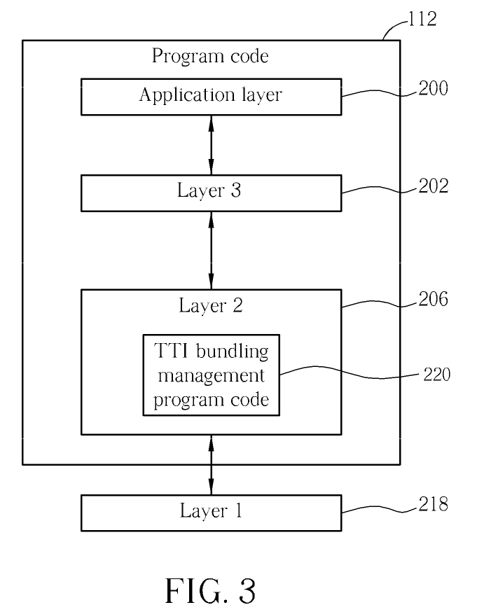

Please continue to refer to FIG. 3. FIG. 3 is a schematic diagram of the program 112 shown in FIG. 3. The program 112 includes an application layer 200, a Layer 3 202, and a Layer 2 206, and is coupled to a Layer 1 218. The Layer 3 202 performs radio resource control. The Layer 2 206 comprises an RLC layer and a MAC layer, and performs link control. The Layer 1 218 performs physical connections.

In LTE, the MAC layer of the Layer 2 206 can perform a transmission time interval (TTI) bundling function for enhancing reliability and accuracy of transmission, to improve uplink coverage. Under such circumstances, when TTI bundling is configured by UE, the embodiment of the present invention provides a TTI bundling management program code 220 to manage TTI bundling transmissions.

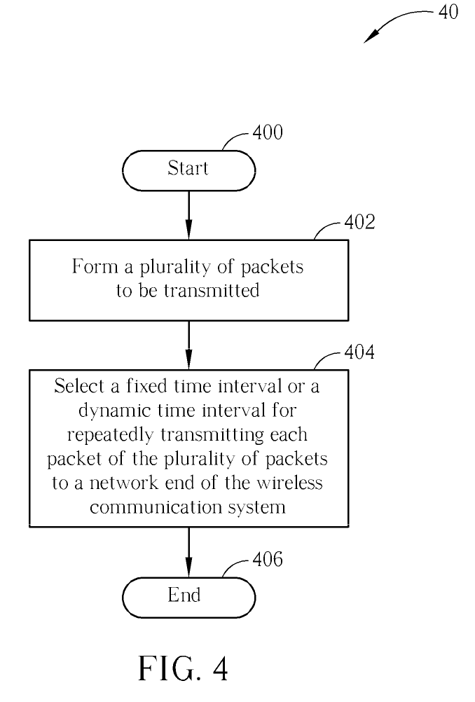

Please refer to FIG. 4, which is a flow chart of a process 40 according to an embodiment of the present invention. The process 40 is used for managing TTI bundling transmissions for a UE of the wireless communication system 1000, and can be compiled into the TTI bundling management program code 220. The process 40 includes the following steps:

Step 400: Start.

Step 402: Form a plurality of packets to be transmitted.

Step 404: Select a fixed time interval or a dynamic time interval for repeatedly transmitting each packet of the plurality of packets to a network end of the wireless communication system.

Step 406: End.

According to the process 40, when performing TTI bundling transmission, the embodiment of the present invention selects the fixed time interval or the dynamic time interval for repeatedly transmitting each packet. In short, in the embodiment of the present invention, the UE repeatedly transmits each packet with the fixed time interval or the dynamic time interval.

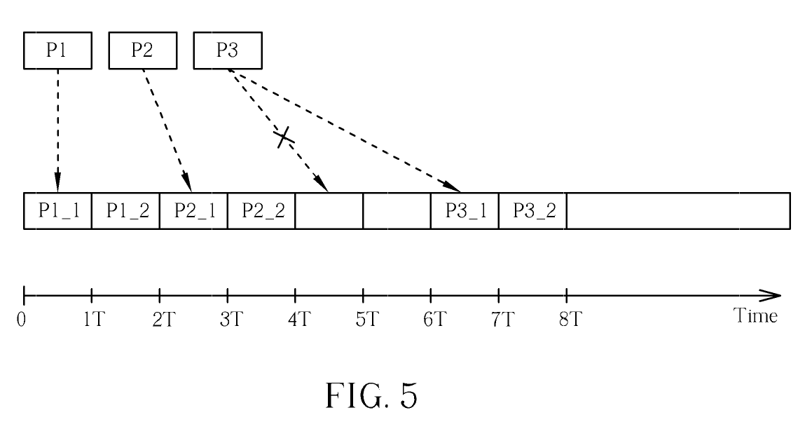

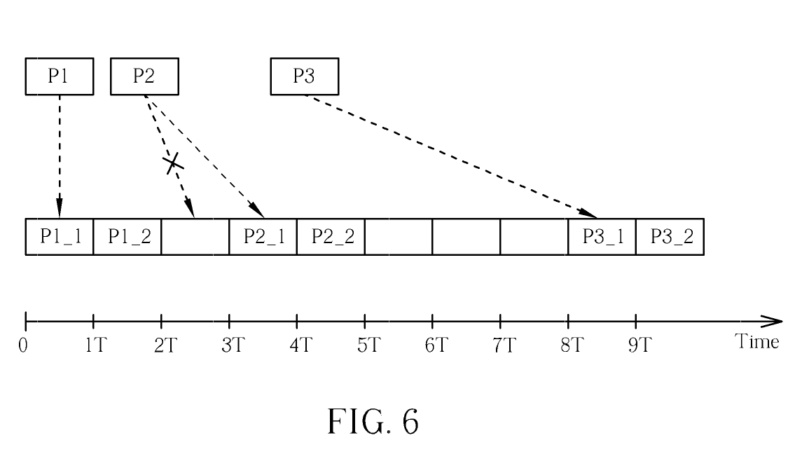

In detail, targeting on one of the packets, the UE forms a plurality of sub-packets corresponding to the packet. Each of the sub-packets can be the same as the packet, or slightly different from the packet because of operations like coding, while the essence of the sub-packets are the same as the packet after decoded. Next, targeting on all the packets, the UE can select the fixed time interval or the dynamic time interval to repeatedly transmit each packet, namely to transmit sub-packets of all the packets to the network end. FIG. 5 and FIG. 6 are schematic diagrams illustrating operation of TTI bundling with the fixed time interval and the dynamic time interval respectively.

In FIG. 5, suppose that time interval is T, packets to transmitted are P1, P2 and P3, and each bundle is composed of two packets, meaning that each packet is transmitted twice. First, the UE transforms packets P1, P2 and P3 into sub-packets P1₁₃ 1, P1_2, P2_1, P2_2, P3_1 and P3_2 in order, and each sub-packet can be the same as or slightly different from a corresponding packet. Next, the UE transmits each sub-packet continuously, that is, after the UE transmits the sub-packets P1_1 and P1_2 at a time point 2T, the UE continues to transmit the sub-packets P2_1 and P2_2. In other words, in FIG. 5, the UE always transmits a bundle in each of two time intervals (0T˜2T, 2T˜4T, etc.), which means that the fixed time interval is corresponding to transmission times of each packet. In such a situation, if transmission delay or packet lost occurs, and causes the UE incapable of repeatedly transmitting packets, the UE waits for next fixed time interval, to transmit a packet. For example, between time points 4T and 5T, the UE cannot transmit the subpakets P3_1 and P3_2, and the UE waits for the next fixed time interval, which is between time points 6T and 7T, to transmit the packet P3 repeatedly.

In comparison, as shown in FIG. 6, the UE repeatedly transmits the packets P1, P2 and P3, namely the sub-packets P1_1, P1_2, P2_1, P2_2, P3_1 and P3_2, with the dynamic time interval. Therefore, when the UE fails to transmits the sub-packets P2_1 and P2_2 corresponding to the packet P2 between time points 2T and 3T, the UE can immediately transmit the sub-packets P2_1 and P2_2 at next time interval (3T˜4T). Similarly, if the packet P3 is not generated just following the packet P2 but with a period between them, then after the packet P3 is formed, the UE can transmit the sub-packets P3_1 and P3_2 immediately.

Note that, FIG. 5 and FIG. 6 illustrate difference between operations of the fixed time interval and the dynamic time interval when two-time transmission is configured. In fact, the time of repeat transmission is not limited to be 2, and can be other values.

Besides, in the present invention, the fixed time interval can be taken as a special case of the dynamic time interval, and those skilled in the art can make modifications and alterations according to different requirements.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for managing transmission time interval bundling transmission in a user equipment of a wireless communication system, the method comprising:
forming a plurality of packets to be transmitted; and
selecting a fixed time interval or a dynamic time interval for repeatedly transmitting each packet of the plurality of packets to a network end of the wireless communication system.

2. The method of claim 1, wherein the fixed time interval is corresponding to times of repeating transmitting each packet of the plurality of packets.

3. The method of claim 1, wherein repeatedly transmitting each packet of the plurality of packets to the network end of the wireless communication system comprises:
forming a plurality of sub-packets corresponding to each packet of the plurality of packets; and
transmitting the plurality of sub-packets corresponding to each packet to the network end.

4. The method of claim 3, wherein the plurality of sub-packets corresponding to each packet are the same.

5. The method of claim 3, wherein the plurality of sub-packets corresponding to each packet are different.

6. The method of claim 1, wherein the wireless communication system is a Long-Term Evolution communication system.

7. A communication device for managing transmission time interval bundling transmission in a user equipment of a wireless communication system, the communication device comprising:
a processor for executing a process; and
a storage device, coupled to the processor, for storing a program for executing the process, wherein the process comprises:
forming a plurality of packets to be transmitted; and
selecting a fixed time interval or a dynamic time interval for repeatedly transmitting each packet of the plurality of packets to a network end of the wireless communication system.

8. The communication device of claim 7, wherein the fixed time interval is corresponding to times of repeating transmitting each packet of the plurality of packets.

9. The communication device of claim 7, wherein repeatedly transmitting each packet of the plurality of packets to the network end of the wireless communication system in the process comprises:
forming a plurality of sub-packets corresponding to each packet of the plurality of packets; and
transmitting the plurality of sub-packets corresponding to each packet to the network end.

10. The communication device of claim 9, wherein the plurality of sub-packets corresponding to each packet are the same.

11. The communication device of claim 9, wherein the plurality of sub-packets corresponding to each packet are different.

12. The communication device of claim 7, wherein the wireless communication system is a Long-Term Evolution communication system.
